(19) United States
(12) Patent Application Publication
(10) Pub. No.: US 2007/0008078 A1
(43) Pub. Date: Jan. 11, 2007

(54) Doorbell device capibile of identifying visitors and the method thereof

(75) Inventor: Layoung Sau, Taipei County (TW)

Correspondence Address: QUINTERO LAW OFFICE, 1617 BROADWAY, 3RD FLOOR, SANTA MONICA, CA, 90404, US

(73) Assignee: LITE-ON TECHNOLOGY CORPORATION, TAIPEI (TW)

(21) Appl. No.: 11/336,227

(22) Filed: Jan. 20, 2006

(30) Foreign Application Priority Data
Jun. 20, 2005 (TW) TW94120421

(51) Int. Cl. G08B 5/00

(52) U.S. Cl. 340/330

(57) ABSTRACT

The invention provides a doorbell device. The doorbell device comprises: a fingerprint sensor module, including a push-button, for sensing a visitor fingerprint to form a first fingerprint data when the visitor presses the push-button to ring the doorbell device; a database, coupled to the fingerprint sensor module, for comparing the first fingerprint data with a plurality of fingerprint data stored in the database to identify the identity of the visitor as a first visitor identity corresponding to the first fingerprint data; an audio processing module, coupled to the database, for storing a plurality of audio signals and playing a first audio signal corresponding to the first visitor identity, wherein the first audio signal is one of the plurality of audio signals; and a loudspeaker, for broadcasting the first audio signal to inform a user of the identity of the visitor.

### BACKGROUND OF THE INVENTION

1. Field of the Invention

The present invention relates to a doorbell device, and more particularly to a doorbell device capable of identifying visitors.

2. Description of the Related Art

Because public security is of increased concern recently, there is a need for a security system to identify visitors to maintain home security. For example, European patent number WO0129795 “Integrated security system with fingerprint imaging door” discloses a doorbell device combined with a fingerprint identifying system to identify a visitor after the visitor rings the doorbell. Thus, the person in the home can determine whether to open the door according to the visitor identity.

However, this doorbell device has some drawbacks. A user must step in front of the doorbell device to see the visitor identity shown on the screen of the doorbell device after the visitor rings the doorbell. This is inconvenient for the user. It is extremely inconvenient for old people with poor sight and children who cannot read. Thus, the doorbell of the invention emits music corresponding to different visitor identities. Because the human ear can discriminate numerous sounds and a human fingerprint characterizes each person, the invention offers a marvelous combination of a fingerprint recognition and musical doorbell.

### BRIEF SUMMARY OF THE INVENTION

The invention provides a doorbell device. An embodiment of the doorbell comprises: a fingerprint sensor module, including a push-button, for sensing a visitor fingerprint to form a first fingerprint data when the visitor presses the push-button to ring the doorbell device; a database, coupled to the fingerprint sensor module, for comparing the first fingerprint data with a plurality of fingerprint data stored in the database to identify the identity of the visitor as a first visitor identity corresponding to the first fingerprint data; an audio processing module, coupled to the database, for storing a plurality of audio signals and playing a first audio signal corresponding to the first visitor identity, wherein the first audio signal is one of the plurality of audio signals; and a loudspeaker, for broadcasting the first audio signal to inform a user of the identity of the visitor.

The invention also provides a method for identifying a visitor ringing a doorbell. An embodiment of the method comprises the following steps. First, a corresponding relationship between a plurality of visitor identities and a plurality of audio signals is built in advance. The visitor fingerprint is then sensed when the visitor rings the doorbell to form a first fingerprint data. The first fingerprint data is then compared with the plurality of fingerprint data stored in a database to identify the identity of the visitor as a first visitor identity corresponding to the first fingerprint data. A first audio signal corresponding to the first visitor identity is then played according to the corresponding relationship to inform a user of the identity of the visitor, wherein the first visitor identity is one of the plurality of visitor identities, and the first audio signal is one of the plurality of audio signals.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a flowchart of a method for identifying a visitor who rings a doorbell according to the invention;

FIG. 2 shows a flowchart of a method for identifying a visitor who rings a doorbell;

FIG. 3 shows a block diagram of a doorbell device according to the invention; and

FIG. 4 shows a corresponding relationship between the plurality of visitor identities and the plurality of audio signals built through the user interface module.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

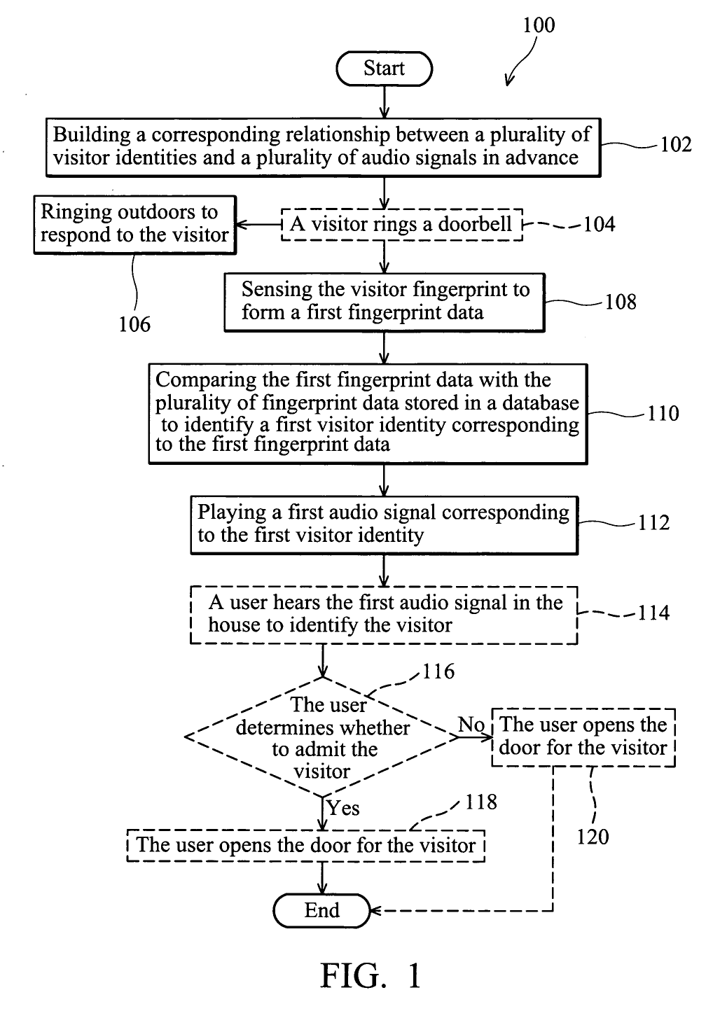

FIG. 1 shows a flowchart of a method 100 for identifying a visitor who rings a doorbell according to the invention. There must be a database for storing a plurality of fingerprint data corresponding to a plurality of visitor identities coupled to the doorbell before the visitor rings the bell. Moreover, there must be an audio processing module coupled to the database for storing and playing a plurality of audio signals. The plurality of audio signals may be pronouncing of names, songs, or music, and may be recorded by a user or downloaded from other electronic devices. A corresponding relationship between the plurality of visitor identities and the plurality of audio signals must be built in advance by the user in step 102, wherein one audio signal may correspond to one visitor identity or one audio signal may correspond to several visitor identities.

In FIG. 1, the steps executed by the doorbell are illustrated with solid lines, but the steps executed by the visitor of the user are illustrated with dotted lines. A visitor is assumed to ring the doorbell in step 104. The doorbell then sounds outdoors to respond to the visitor in step 106, and the visitor can confirm that he has rung the doorbell successfully. At the same time, the doorbell senses the visitor fingerprint to form a first fingerprint data in step 108. The first fingerprint data is then compared with the plurality of fingerprint data stored in the database in step 110 to identify the identity of the visitor as a first visitor identity corresponding to the first fingerprint data.

Because a relationship between the plurality of visitor identities stored in the database and the plurality of audio signals stored in the audio processing module is built in advance, a first audio signal corresponding to the first visitor identity is played by the audio signal processing module in step 112. When a user in the house hears the first audio signal in step 114, the visitor is identified by the user because the user knows the first visitor identity corresponding to the first audio signal. The user can then determine whether he welcomes the visitor in step 116 and open the door for the visitor in step 118 or deny the visitor in step 120.

Moreover, when the visitor visits the house for the first time, the visitor cannot be identified because there is no fingerprint data of the visitor in the database for comparison. At this moment, the visitor fingerprint data will be stored in the database, and a visitor identity corresponding to the fingerprint data must be inputted and recorded in the database. After the fingerprint data is stored, the user must still assign an audio signal corresponding to the visitor identity. Once the visitor visits again and rings the doorbell, the audio signal will be played according to his fingerprint, and the user can identify the visitor according to the audio signal.

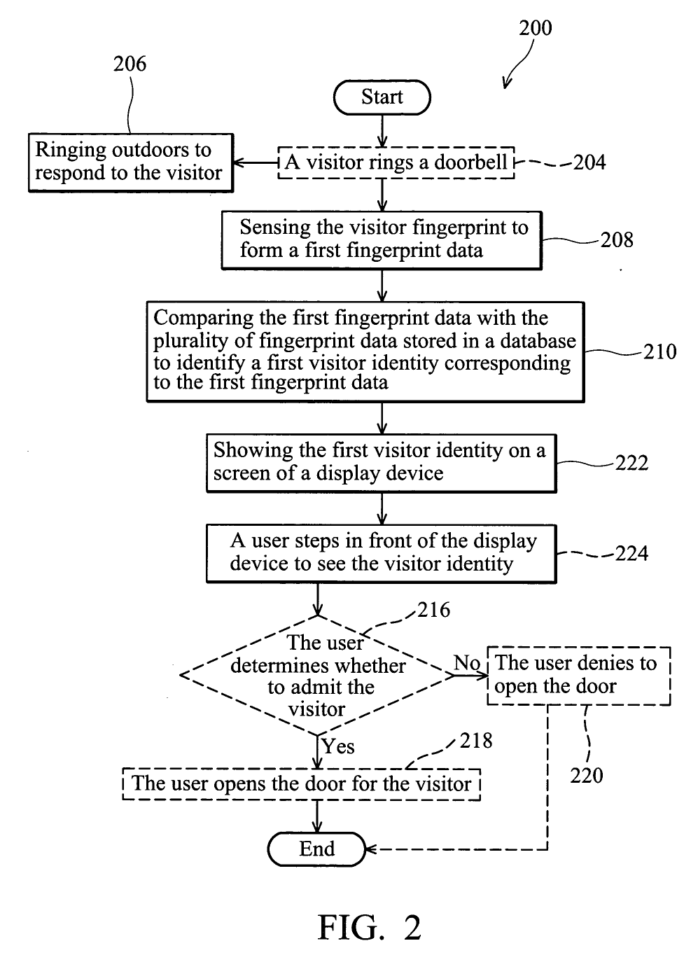

FIG. 2 shows a flowchart of a method 200 for identifying a visitor who rings a doorbell. Most steps of the method 200 are identical to the steps of the method 100, such as steps 204, 206, 208, 210, 216, 218, and 220. However, after a first visitor identity is identified in the step 210 according to the first fingerprint data of the visitor, the first visitor identity is shown on a screen of a display device in step 222. Because method 200 does not play an audio signal as does the method 100 corresponding to the first visitor identity, the user must step before the display device to see the visitor identity on the screen in step 224, no matter where the user is. This is very inconvenient for the user, and the advantage of method 100 is apparent when compared with method 200.

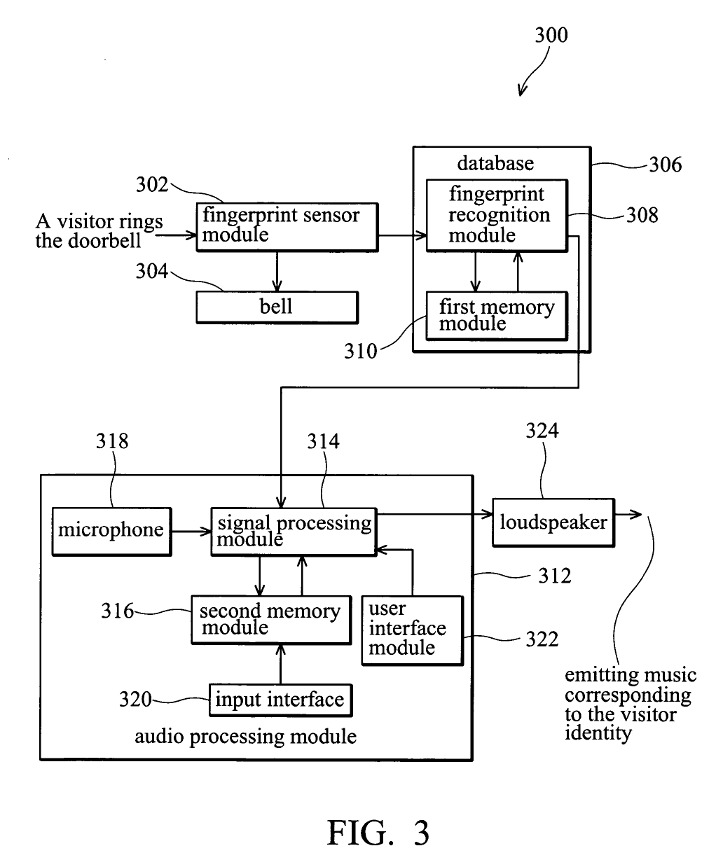

FIG. 3 shows a block diagram of a doorbell device 300 according to the invention. The doorbell device 300 is capable of implementing method 100 in FIG. 1. The doorbell device 300 includes a fingerprint sensor module 302. The fingerprint sensor module 302 includes a push-button. When a visitor pushes the push-button, a bell 304 coupled to the push-button rings outdoors to respond to the visitor. At the same time, the fingerprint sensor module 302 senses the visitor fingerprint to form a first fingerprint data.

A database 306 includes two modules: a fingerprint recognition module 308, and a first memory module 310. The first memory module 310 is capable of storing a plurality of fingerprint data and corresponding visitor identities. When the first fingerprint data is received by the database 300, the fingerprint recognition module 308 compares the first fingerprint data with the plurality of fingerprint data stored in the first memory module 310. If there is a second fingerprint data which is one of the plurality of fingerprint data and tallies with the first fingerprint data, the fingerprint recognition module 308 outputs a first visitor identity corresponding to the second fingerprint data. If none of the plurality of fingerprint data stored in the first memory module 310 tallies with the first fingerprint data, the first fingerprint data is a new fingerprint data and is stored in the first memory module 310. The user will then input a new visitor identity corresponding to the first fingerprint data to be stored in the first memory module 310.

The audio processing module 312 is capable of playing a first audio signal corresponding to the first visitor identity received from the database 306. The audio processing module 312 includes five modules: a signal processing module 314, a second memory module 316, a microphone 318, an input interface 320, and a user interface module 322. The microphone 318 is capable of receiving outside sounds and transforming the outside sounds into an analog audio signal. The signal processing module 314 then converts the analog audio signal to a digital audio signal to be stored in the second memory module 316. The input interface 320 is capable of receiving digital audio signals from other electronic devices to be stored in the second memory module 316. Thus, the second memory module 316 is capable of storing a plurality of audio signals.

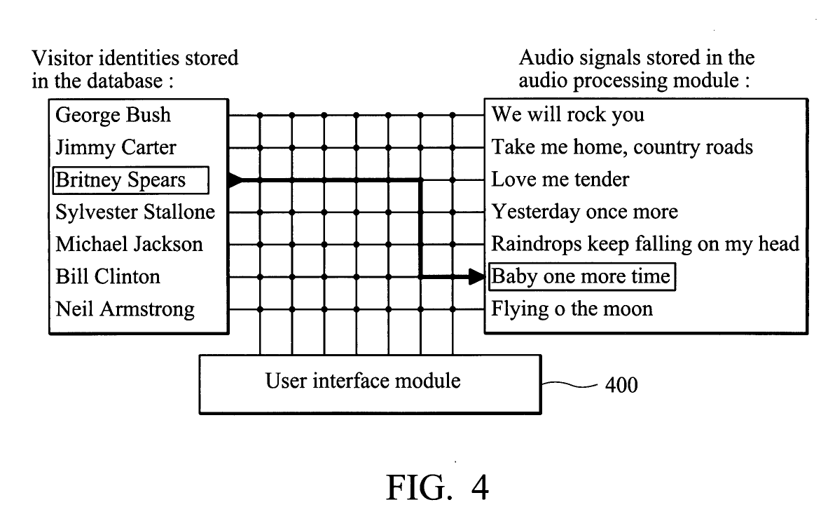

A user can build the corresponding relationship between the plurality of visitor identities stored in the first memory module 310 and the plurality of audio signals stored in the second memory module 316 through the user interface module 322. The user interface module 322 will be described with reference to FIG. 4. When the first visitor identity outputted from the database 306 is received by the signal processing module 314, a first audio signal corresponding to the first visitor identity is retrieved from the second memory module 316 by the signal processing module 314. The signal processing module 314 then converts the first audio signal from digital to analog form to be played with a loudspeaker 324. Thus, when the user in the house hears the first audio signal, he can identify the visitor with the rhythm of the first audio signal. The user can then determine whether to admit the visitor and open the door for the visitor or deny the visitor.

FIG. 4 shows a corresponding relationship between the plurality of visitor identities and the plurality of audio signals built through the user interface module 400. The first memory module 310 of the database 306 in FIG. 3 is assumed to store seven visitor identities, and the second memory module 316 of the audio processing module 312 in FIG. 3 is assumed to store seven audio signals. The user assigns the audio signal of “Baby one more time” to the visitor identity of “Britney Spears” through the user interface module 400 to build a corresponding relationship between the audio signal of “Baby one more time” and the visitor identity of “Britney Spears”. Thus, when the audio processing module 312 receives a visitor identity of “Britney Spears”, it plays the audio signal of “Baby one more time”, and the user will know that Britney Spears has come when he hears the rhythm of “Baby one more time”.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A doorbell device, comprising:
a fingerprint sensor module, including a push-button, for sensing a visitor fingerprint to form a first fingerprint data when the visitor presses the push-button to ring the doorbell device;
a database, coupled to the fingerprint sensor module, for comparing the first fingerprint data with a plurality of fingerprint data stored in the database to identify the identity of the visitor as a first visitor identity corresponding to the first fingerprint data;
an audio processing module, coupled to the database, for storing a plurality of audio signals and playing a first audio signal corresponding to the first visitor identity, wherein the first audio signal is one of the plurality of audio signals; and
a loudspeaker, for broadcasting the first audio signal to inform a user of the identity of the visitor.

2. The doorbell device as claimed in claim 1, wherein the database comprises:
a first memory module, for storing the plurality of fingerprint data and a plurality of visitor identities corresponding to the plurality of fingerprint data; and
a fingerprint recognition module, coupled to the first memory module and the fingerprint sensor module, for finding a second fingerprint data corresponding to the first fingerprint data among the plurality of fingerprint data, and outputting the first visitor identity which is one of the plurality of the visitor identities and corresponds to the second fingerprint data.

3. The doorbell device as claimed in claim 1, wherein the database stores a plurality of visitor identities corresponding to the plurality of fingerprint data, the audio processing module includes a user interface module for allowing the user to build a corresponding relationship between the plurality of visitor identities stored in the database and the plurality of audio signals stored in the audio processing module.

4. The doorbell device as claimed in claim 3, wherein the audio processing module further comprises:
a second memory module, for storing the plurality of audio signals and the corresponding relationship between the plurality of audio signals and the plurality of visitor identities; and
a signal processing module, coupled to the second memory module and the database, for retrieving the first audio signal corresponding to the first visitor identity from the second memory module according to the corresponding relationship, and delivering the first audio signal to the loudspeaker.

5. The doorbell device as claimed in claim 4, wherein the audio processing module further comprises a microphone coupled to the signal processing module for receiving outside sounds to be recorded by the signal processing module as one of the plurality of audio signals stored in the second memory module.

6. The doorbell device as claimed in claim 4, wherein the audio processing module further comprises an input interface coupled to the second memory module for receiving audio signals from other electronic devices to be stored in the second memory module as one of the plurality of audio signals.

7. The doorbell device as claimed in claim 1, wherein the plurality of audio signals are selected from the group of sounds recorded by the user, pronouncing of names, songs, or music.

8. The doorbell device as claimed in claim 1, wherein the doorbell device further comprises a bell coupled to the push-button for ringing outdoors when the visitor pushes the push-button.

9. A method for identifying a visitor who rings a doorbell, comprising the steps of:
building a corresponding relationship between a plurality of visitor identities and a plurality of audio signals in advance;
sensing the visitor fingerprint when the visitor rings the doorbell to form a first fingerprint data;
comparing the first fingerprint data with the plurality of fingerprint data stored in a database to identify the identity of the visitor as a first visitor identity corresponding to the first fingerprint data; and
playing a first audio signal corresponding to the first visitor identity according to the corresponding relationship to inform a user of the identity of the visitor;
wherein the first visitor identity is one of the plurality of visitor identities, and the first audio signal is one of the plurality of audio signals.

10. The method as claimed in claim 9, wherein the comparing step includes the step of:
finding a second fingerprint data corresponding to the first fingerprint data among the plurality of fingerprint data; and
outputting the first visitor identity corresponds to the second fingerprint data.

11. The method as claimed in claim 9, wherein the plurality of audio signals are selected from the group of sounds recorded by the user, pronouncing of names, songs, or music.

12. The method as claimed in claim 9, wherein the method further comprises the step of ringing outdoors when the visitor rings the doorbell.
